(19) United States
(12) Patent Application Publication
(10) Pub. No.: US 2006/0222210 A1
(43) Pub. Date: Oct. 5, 2006

(54) System, method and computer program product for determining whether to accept a subject for enrollment

(75) Inventor: Prabha Sundaram, Sunnyvale, CA (US)

Correspondence Address: SQUIRE, SANDERS & DEMPSEY L.L.P, 600 HANSEN WAY, PALO ALTO, CA, 94304-1043, US

(73) Assignee: Hitachi, Ltd.

(21) Appl. No.: 11/096,668

(22) Filed: Mar. 31, 2005

(51) Int. Cl. G06K 9/00

(52) U.S. Cl. 382/115

(57) ABSTRACT

Embodiments of a system, method and computer program product are described for determining whether to accept a subject for enrollment in a biometric system. In accordance with one embodiment, a template may be generated from feature vectors extracted from a first instance of a biometric input obtained from a subject. Feature vectors extracted from a second instance of the biometric input obtained from the subject may be compared to the template to generate a match score based on a degree of similarity between the first and second instances of the biometric inputs. The subject may be accepted for enrollment in a biometric system if the match score meets a threshold criteria.

### TECHNICAL FIELD

Embodiments described herein relate generally to data processing, and more particularly, to enrollment in biometric systems.

### BACKGROUND

Biometrics is the science and technology of measuring and statistically analyzing biological data. A biometric is a measurable, physical characteristic or personal behavioral trait used to recognize the identity, or verify the claimed identity, of an enrollee. In general, biometrics statistically measure certain human anatomical and physiological traits that are unique to an individual. Examples of biometrics include fingerprints, retinal scans, speaker (voice) recognition, signature recognition, and hand recognition. Biometrics may be utilized for identification and/or verification. In identification, a biometric sample (i.e., a biometric input) of a subject (e.g., a person) may be compared against biometric data stored in a biometric system in order to establish the identity of the subject. Verification (also known as authentication) is a process of verifying a subject is who that subject claims to be. Identification is a process for ascertaining the identity of a given subject. A goal of verification is to determine if the subject (also referred to as a claimant) is the authentic enrolled subject (also referred to as a genuine or valid subject) or an impostor.

Speaker verification systems (also known as voice verification systems) attempt to match a voice of a speaker whose identity is undergoing verification with a known voice. Speaker verification systems help to provide a means for ensuring secure access by using speech utterances. Verbal submission of a word or phrase or simply a sample of an individual speaker's speaking of a randomly selected word or phrase are provided by a claimant when seeking access to pass through a speaker recognition and/or speaker verification system. An authentic claimant is one whose utterance matches known characteristics associated with the claimed identity.

In a biometric system, enrollment may be defined as the initial process of collecting biometric data samples (i.e., biometric input) from a person (i.e., a subject) and subsequently storing the data in a reference template representing a subject's identity to be used for later comparison. In enrollment, a subject may provide biometric input (e.g., voice, fingerprint, etc) to a biometric data acquisition system. Because small changes in environment can change the characteristics of the acquired biometric, several samples of the person's biometric data are normally captured in order to create a reference template for the subject. However, due to insufficiently distinctive biometrics, it may be difficult to enroll a person in such a biometric system in a manner that would permit the person to be subsequently recognized by the system during identification and/or verification. Such a condition is referred to as failure to enroll. A failure to enroll condition may occur due to various reasons such as, for example: insufficient distinctive biometrics (e.g., the fingerprints of people who work extensively at manual labor often are too worn to be captured) the biometric implementation which makes it difficult to provide consistent biometric data (e.g., a high percentage of people are unable to enroll in retina recognition systems because of the precision such systems require).

The rate of the failure to enroll condition (referred to as the “failure to enroll rate”) is one metric that may be used to measure the performance of a biometrics system. The failure to enroll rate may be defined as the rate of failure of a given biometric system in creating a proper enrollment template for a subject. The failure to enroll mechanism is often used for quality control during the enrollment process by eliminating unreliable biometric data/subjects from the system.

### SUMMARY

Embodiments of a system, method and computer program product are described for determining whether to accept or reject a subject for enrollment in a biometric system based on biometric input of the subject. In accordance with one embodiment, a reference template may be generated from feature vectors extracted from a first instance (e.g., a first occurrence) of a biometric input obtained from a subject. Feature vectors extracted from a second instance (e.g., a second occurrence) of the biometric input obtained from the subject may be compared to the reference template to generate a match score based on a degree of similarity/dissimilarity between the first and second instances of the biometric inputs. The second instance of the biometric input comprises a repetition of the first instance of the biometric input. The subject may be accepted for enrollment in a biometric system if the match score meets a threshold criteria.

However, if the match score fails to meet the threshold criteria, then the subject may be rejected for enrollment in the biometric system. The threshold criteria may be based on an equal error rate between valid (or genuine) subjects and imposters. The equal error rate may be defined by a point of intersection between a probability density function for valid subjects and a probability density function for imposters.

In one embodiment, the biometric inputs may each comprise a speech utterance. In such an embodiment, each speech utterance may have a duration less than about three seconds. In another implementation, each speech utterance may have a duration less than about two seconds.

The match score may comprise a distortion score that represents a degree of distortion of the feature vectors of the second instance of the biometric input from the template generated from the feature vectors extracted from the first instance of the biometric input. In one embodiment, the reference template may comprise sixteen or less codewords and may, in one implementation, comprise an eight codeword reference template.

In one embodiment, feature vectors extracted from a third instance (e.g., a third occurrence) of the biometric input of the subject may also be compared to the reference template to generate a match score based on a degree of similarity/dissimilarity between the first and third instances of the biometric inputs.

Enrollment of the subject may include the generating of a code book for the subject based on at least the first and second instances of the biometric input.

### BRIEF DESCRIPTION OF THE DRAWINGS

FIG. 1 is a schematic block diagram of an exemplary biometric enrollment system in accordance with an illustrative embodiment;

FIG. 2 is a flowchart of an exemplary process for implementing a failure to enroll mechanism in accordance with an illustrative embodiment;

FIG. 3 is a flowchart of an exemplary training process for generating threshold values in accordance with an illustrative embodiment of a biometric system utilizing speech; and

FIG. 4 is a graphical representation of a cumulative probability density function for an illustrative biometric system implemented with short duration speech utterances as biometric input.

### DETAILED DESCRIPTION

Embodiments described herein for implementing a procedure for determining whether the quality of a user's biometric input, such as, for example the user's voice quality, is sufficiently reliable for creating a unique reference template for the user for use in a biometric verification and/or identification system. Implementation of such a mechanism may be useful in helping improve performance of a biometric system by helping previous incorrect rejection of genuine or valid subjects (e.g., genuine speakers) or incorrect acceptance of imposters. For example, various embodiments described herein may be utilized to detect such inconsistencies in the acquired biometric and thereby detect a failure to enroll state for a biometrics system.

In general, a reference template may be generated from feature vectors extracted from a first instance (e.g., a first occurrence) of a biometric input (e.g., a speech utterance) obtained from a subject. Feature vectors extracted from a second instance (e.g., a second occurrence) of the biometric input obtained from the subject may be compared to the reference template to generate a match score based on a degree of similarity/dissimilarity between the first and second instances of the biometric inputs. The second instance of the biometric input comprises a repetition of the first instance of the biometric input. The subject may be accepted for enrollment in a biometric system if the match score meets a threshold criteria. However, if the match score fails to meet the threshold criteria, then the subject may be rejected for enrollment in the biometric system. The threshold criteria may be based on an equal error rate between valid (or genuine) subjects and imposters. The equal error rate may be defined by a point of intersection between a probability density function for valid subjects and a probability density function for imposters. In one embodiment, feature vectors may be extracted from a third instance (e.g., a third occurrence) of the biometric input of the subject and compared to the reference template to generate a match score based on a degree of similarity/dissimilarity between the first and third instances of the biometric inputs. In one implementation, each speech utterance may have a duration less than about three seconds. In another implementation, each speech utterance may have a duration less than about two seconds. The match score may comprise a distortion score that represents a degree of distortion of the feature vectors of the second instance of the biometric input from the template generated from the feature vectors extracted from the first instance of the biometric input.

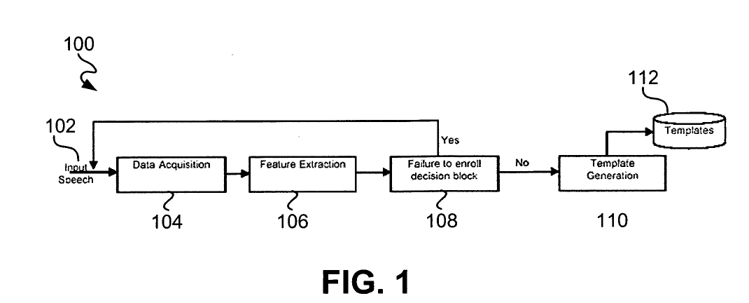

FIG. 1 is a schematic block diagram of an exemplary biometric enrollment system 100 that may be utilized for implementing a failure to enroll mechanism in accordance with an illustrative embodiment. In this exemplary biometric enrollment system 100, a user's biometric input 102 (e.g., a spoken utterance made by the user) may be acquired by a data acquisition component 104. In an embodiment where the biometric input comprises a spoken utterance made by a user, the spoken utterance may comprise, for example, a password spoken by the user. The data acquisition component may record 104 the user's biometric input and provide the captured biometric input to a feature extraction component 106. In one embodiment, the data acquisition component may include a buffer for temporality storing the biometric input. In a speech implementation, the buffer may be referred to as an input speech buffer. The feature extraction component 106 processes the captured biometric input to extract characteristic features of the biometric input called feature vectors. Feature vectors may comprise, for example, unique, identifiable features of the biometric input.

The extracted feature vectors may be provided to an enrollment component 108 (also referred to as a “failure to enroll decision component”) that can determine whether to enroll the user into the biometric system based on the quality of the biometric input by analyzing the extracted feature vectors. In an implementation where the biometric input comprises a spoken utterance, the enrollment component may determine whether the recorded utterance is of sufficient quality for use in generating a unique voice pattern of the user that can be subsequently be used to identify the user. If the enrollment component 108 determines that the recorded biometric input can be used to create a unique pattern for the user (i.e., the extracted features are determined to be of sufficient or good enough quality), then the “No” path may be followed and a template generation component 110 can generate a template for the user based on the extracted feature vectors using, for example, a pattern matching technique(s). The generated template may be stored in a template database 112. In an implementation where the biometric input is speech, the generated template may comprise a unique voiceprint of the user.

Conversely, if the enrollment component 108 determines that the recorded biometric input cannot be used to create a unique pattern for the user (in other words, the biometric input is too poor of quality to be used in the biometric system), then a failure to enroll error may be generated (as represented by the “Yes” path).

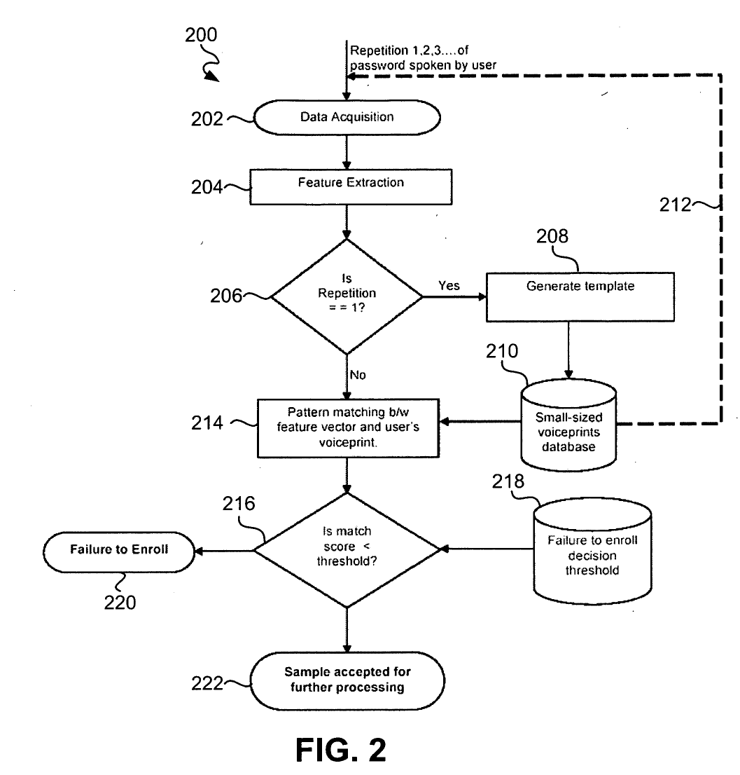

FIG. 2 is a flowchart of an exemplary process 200 for implementing a failure to enroll mechanism in accordance with an illustrative embodiment. This process 200 may be implemented, for example, as a precursor to or as a portion of a biometric enrollment procedure for use in an biometric verification and/or identification system. An embodiment of this process 200 may be used in a biometric system using spoken utterances for the biometric input of a user (such biometric systems may be referred to as “speech biometric systems”) and may be especially useful in speech biometric systems using short duration utterances, such as for example, spoken utterances having a duration of two to three seconds or less. An embodiment of this process 200 may be carried out using the exemplary system 100 of FIG. 1.

As part of the process 200, the user may be prompted to provide multiple samples of the user's biometric input. For example, in one implementation, the enrollment system may request that the user provide at least two repetitions of the same spoken utterance (e.g., a spoken password). Embodiments of the process 200 will now be described as follows in the context where a user provides at least three repetitions of the same biometric input (e.g., at least three repetitions of the same spoken utterance).

An initial biometric input of a user may be obtained in a data acquisition operation 202. In one embodiment, this initial biometric input of may be obtained from the user in response to an appropriate prompt presented to the user. In the exemplary system 100 of FIG. 1, the data acquisition operation 202 may be performed by the data acquisition component 104. In a speech implementation, the obtained biometric input may comprise, for example, a password spoken by the user.

Feature vectors may be extracted in a feature extraction operation 204 from the biometric input captured in extraction operation 202. In the exemplary system 100, the extraction operation 204 may be performed by the feature extraction component 106.

At decision 206, if the biometric input of the user is an initial biometric input (i.e., a “first instance” or “first repetition”) received from the user, then the repetition number is equal to one and the “Yes” path is followed and a preliminary template (or “reference template”) for the user may be generated based on the features vectors of the initial biometric input in a generate template operation 208. The generated preliminary template of the user may be stored in a template database 210. In an spoken utterance implementation, if the spoken utterances are of short duration (i.e., less than two to three seconds), the biometric input may not exhibit very many phonetic variations. As a consequence, these limited phonetic variations can be modeled with a small sized template such as, for example, an eight to sixteen point vector quantization codebook. In such an implementation, the use of a larger sized codebook may cause over fitting of the limited data available.

After the reference template has been generated, return 212 is followed and feature vectors are extracted from a second repetition (or “second instance”) of the biometric input obtained from user that may be obtained through a second pass of operations 202 and 204. The second instance of the biometric may be obtained from the user in response, for example, to a corresponding prompt (e.g., a request) made to the user.

In the second pass at decision 206, the “No” path is followed for the second biometric input (i.e., the repetition number does not equal one) and, in a pattern matching operation 214, the feature vectors extracted from the second repetition of the biometric input may be compared against the user's preliminary template retrieved from the preliminary template database 210. For example, in one embodiment, the feature vectors extracted from the second repetition of the biometric input may be compared against the feature vectors of the first repetition of the biometric input. A match score (e.g., a distortion score) that represents the degree of similarity/dissimilarity between the feature vectors of the second biometric input and the preliminary template is output as a result of the comparison in pattern matching operation 214.

In threshold decision 216, the output match score may be compared to a threshold value obtained from a failure to enroll decision threshold date store 218. If the match score exceeds the threshold value in decision 216 (e.g., the distortion score indicates that there may be too much dissimilarity between the first and second biometric inputs (i.e., the second biometric input is too dissimilar to the first biometric input), the second biometric input can be determined to be of insufficient quality to be used in enrollment and a failure to enroll error is generated in operation 220 (and thereby indicate a failure to enroll state) and the sample may be rejected. In one embodiment, the failure to enroll decision threshold date store 218 from which the threshold value used in decision 216 may be provided may be populated by an off-line training and statistical analysis process.

On the other hand, if the match score is less than the threshold value (e.g., the distortion score indicates that the dissimilarity between the first and second biometrics is within an acceptable range of similarity for using the biometric inputs to enroll the user in the biometric system (i.e., these biometric inputs can be used to enroll the user in the biometric system)), then at least the first and second biometric inputs may be used for furthering processing for enrolling the user in the biometric system in an accepted for further sampling operation 222.

The process 200 may be repeated for a third repetition of the biometric input (or a “third biometric input”). In this iteration of the process, feature vectors extracted from the third biometric input (see operation 204) may also be compared to the reference template generated from the feature vectors of the first biometric input to determine whether the feature vectors of the third biometric input is within a sufficient range of dissimilarity to the feature vectors of the first biometric input and therefore suitable for use in enrolling the user in the biometric system.

In one embodiment, the user may be prompted to provide the third repetition of the biometric input after the second repetition has been processed at least through operation 216. In another embodiment, the second and third biometric inputs may be provided by the user one right after another. In such an embodiment, the second and third biometric inputs may be processed in parallel (i.e., two iterations of the process 200 carried out relatively simultaneously or in parallel) or the third biometric input can be buffered in the system and processed after the second biometric input (i.e., the two iterations of the process 200 are carried out sequentially, one after the other).

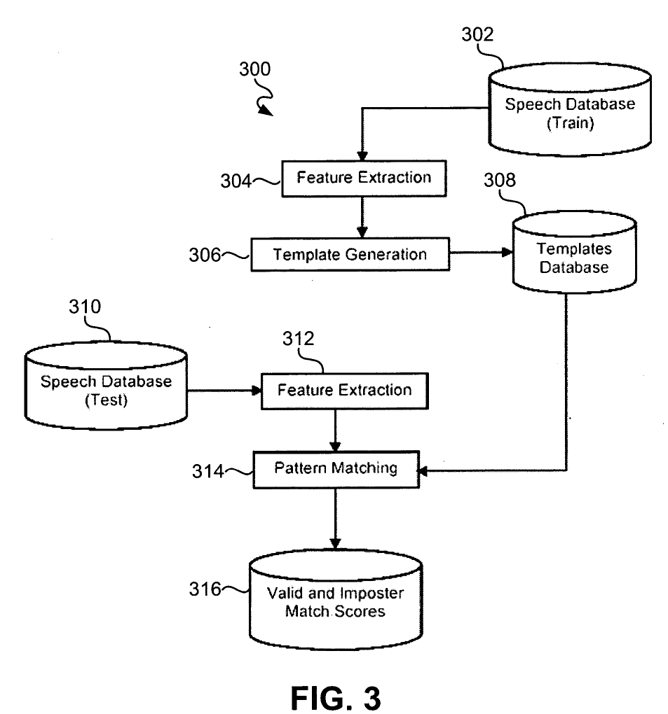

As previously mentioned, the failure to enroll decision threshold date store 218 from which the threshold value used in decision 216 may be provided may be populated by an off-line training and statistical analysis process. FIG. 3 is a flowchart of an exemplary process 300 for generating threshold values in accordance with an illustrative embodiment of a biometric system utilizing speech (i.e., spoken utterances). While the process is described in terms of a speech biometric system, it should be understood that embodiments of this process may be implemented in biometric systems using other types of biometric input. The threshold values generated in such a process 300 may be used in embodiments of the process 200 set forth in FIG. 2. In particular, threshold values generated by process 300 may be used in the failure to enroll threshold determination 216 and may be stored in the threshold database 218. In one embodiment, the training process 300 may be performed off-line from process 200 of FIG. 2.

The threshold generating process 300 may utilize a training database 302 containing a set of spoken utterances (e.g., spoken passwords) from a given set of speakers with each speaker having a plurality of repetitions of their associated spoken utterances stored in the training database 302. For example, for each speaker, the training database may contain copies of multiple repetitions of a spoken password made by the given speaker. In an embodiment implemented for short duration utterances, all of the utterances in the database may comprises short duration utterances (e.g., less than three or three seconds of speech).

For each speaker in the training database 302, feature vectors may be extracted from the stored spoken utterances (i.e., biometric inputs) of that particular speaker in a feature extraction operation 304 and used to generate a template for the speaker (using, e.g., a pattern matching technique) in a template generation operation 306. In an embodiment implemented for short utterances, the generated reference templates may comprise eight and/or sixteen-point reference templates generated using a low complexity and/or low computational pattern matching technique capable of generating eight and/or sixteen-point reference templates. The generated templates may be stored in a template database 308.

The threshold generating process 300 may also utilize a test database 310 that is a copy of the training database so that the test database 310 contains a copy of the same spoken utterances from the same set of speakers as is contained in the training database 302 (it should be noted that the training and test database may be mutually exclusive). In a feature extraction operation 312 (similar to operation 304), feature vectors may be extracted from the plurality of spoken utterances repetitions stored in the test database for each speaker. The template generation process comprises feature extraction of several repetitions of the spoken password and a pattern matching technique that generates eight or sixteen point reference templates. For each speaker, the template generated in operation 306 is retrieved from the template database 308 and compared against the feature vectors of the speaker extracted in operation 312 in a pattern matching operation 314. Each speaker's biometric data from the test database is matched against corresponding feature vectors and/or codewords of the template obtain a match score for each speaker that reflect the degree of similarity/dissimilarity between the feature vectors extracted from the given speaker's utterance in the test database and those feature vectors of the template (i.e., the feature vectors extracted from the copy of the utterance obtained from the training database). These match scores comprise a set of valid match scores (or genuine user match scores) that may be stored in a valid and imposter match score database 316

Using the process 300, match scores may also be generated for imposters (“imposter match scores”). To generate imposter match scores, the pattern matching operation 314 may further involve comparing each speaker's biometric data with the speaker speaking passwords other than the expected password (invalid password spoken by the valid speaker) against the template of the valid password. The match scores generated from this comparison may comprise a set of imposter scores that may be stored in the match score database 316. The imposter match scores may also include scores derived from a comparison of incomplete spoken utterances made by valid/genuine speakers. In one embodiment, each speaker's biometric data from the test database may also be matched against all other speaker's templates to and the scores derived from this comparison may be included in the set of imposter match scores.

The distribution of the valid match scores and imposter match scores generated in the process 300 may be modeled by a cumulative distribution.

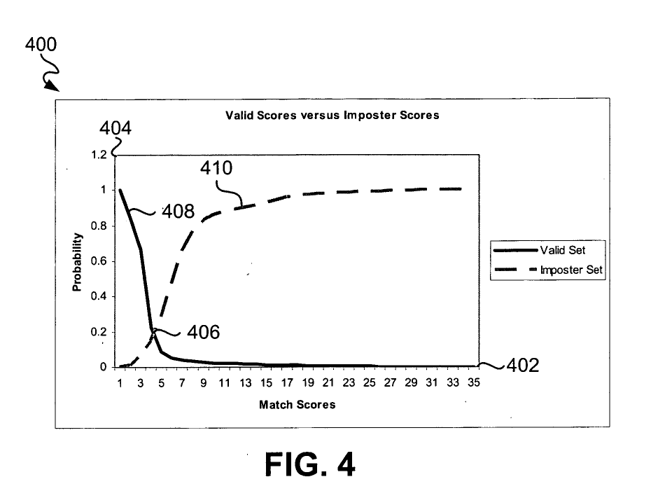

FIG. 4 is a graphical representation 400 of a cumulative probability density function for an illustrative biometric system implemented with short duration speech utterances as biometric input. As shown in FIG. 4, the probability density function graph 400 has an axis 402 for match score values (e.g., distortion score values) and a probability axis 404. The point of intersection 406 (referred to as the “critical threshold” or “equal error rate” or “crossover error rate”) between the normal curves of the set of valid match scores 408 (i.e., the probability density function of valid (or genuine) subjects) and the set of imposter match scores 410 (i.e., the probability density function of imposters) represents a point of maximum separation between valid speakers and imposters. At the critical threshold, the proportion of false acceptances (i.e., acceptances of imposters by the system) may be equal to the proportion of false rejections (i.e., rejections of valid subjects by the system).

In one exemplary biometric system implementation utilizing short duration speech utterances, it has been observed that if a valid speaker's match scores fell within 1.33 times the critical threshold, then such a speaker's voice quality may be sufficiently reliable enough for a biometric system to subsequently make acceptance/rejection decisions. This set of thresholds helps reject incompletely spoken passwords by a valid speaker. To generate the thresholds, the match scores that are dumped correspond to match scores generated by comparing templates generated using three repetitions of the spoken password against the test password. During an actual online enrollment process, repetitions of the password may be compared against a template that is generated using one repetition of the password. In such an implementation, these match scores have a different score range when compared to the score range for the offline training match scores and the 33% increase to the critical threshold may be used to take into account the variation in the score ranges.

Accordingly, an exemplary failure to enroll (FTE) threshold may be calculated as follows:
FTE threshold=critical threshold+0.33*critical threshold

The calculated failure to enroll threshold may be stored in a thresholds database (e.g., database 218 presented in FIG. 2) and may be used to make decisions during enrollment of speakers with the system (e.g., decision 216 present in FIG. 2).

The various embodiment of the failure to enroll mechanism described herein may be implemented to improve a biometrics system's (e.g., a voice biometric system) performance by providing a screen or filter to help prevent the registration of overly unreliable users for use with a given biometric system. Embodiments of the failure to enroll mechanism may be useful in low complexity biometric systems that use fixed short duration spoken passwords as the template size is small (i.e., the template may have a small memory size).

The various embodiments described herein may further be implemented using computer programming or engineering techniques including computer software, firmware, hardware or any combination or subset thereof. While components set forth herein may be described as having various sub-components, the various sub-components may also be considered components of the system. For example, particular software modules executed on any component of the system may also be considered components of the system. In addition, embodiments or components thereof may be implemented on computers having a central processing unit such as a microprocessor, and a number of other units interconnected via a bus. Such computers may also include Random Access Memory (RAM), Read Only Memory (ROM), an I/O adapter for connecting peripheral devices such as, for example, disk storage units and printers to the bus, a user interface adapter for connecting various user interface devices such as, for example, a keyboard, a mouse, a speaker, a microphone, and/or other user interface devices such as a touch screen or a digital camera to the bus, a communication adapter for connecting the computer to a communication network (e.g., a data processing network) and a display adapter for connecting the bus to a display device. The computer may utilize an operating system such as, for example, a Microsoft Windows operating system (O/S), a Macintosh O/S, a Linux O/S and/or a UNIX O/S. Those of ordinary skill in the art will appreciate that embodiments may also be implemented on platforms and operating systems other than those mentioned.

Embodiments of the present invention may also be implemented using computer program languages such as, for example, ActiveX, Java, C, and the C++ language and utilize object oriented programming methodology. Any such resulting program, having computer-readable code, may be embodied or provided within one or more computer-readable media, thereby making a computer program product (i.e., an article of manufacture). The computer readable media may be, for instance, a fixed (hard) drive, diskette, optical disk, magnetic tape, semiconductor memory such as read-only memory (ROM), etc., or any transmitting/receiving medium such as the Internet or other communication network or link. The article of manufacture containing the computer code may be made and/or used by executing the code directly from one medium, by copying the code from one medium to another medium, or by transmitting the code over a network.

One of ordinary skilled in the art will easily be able to combine software with appropriate general purpose or special purpose computer hardware to create a computer system or computer sub-system for implementing various embodiments described herein.

While various embodiments have been described, they have been presented by way of example only, and not limitation. Thus, the breadth and scope of any embodiment should not be limited by any of the above described exemplary embodiments, but should be defined only in accordance with the following claims and their equivalents.

What is claimed:

1. A method of determining whether to accept a subject for enrollment, comprising:
generating a template from feature vectors extracted from a first instance of a biometric input of a subject;
comparing feature vectors extracted from a second instance of the biometric input of the subject to the template to generate a match score based on a degree of similarity between the first and second instances of the biometric inputs; and
accepting the subject for enrollment in a biometric system if the match score meets a threshold criteria.

2. The method of claim 1, wherein the subject is rejected for enrollment in the biometric system if the match score fails to meet the threshold criteria.

3. The method of claim 1, wherein each biometric input comprises a speech utterance.

4. The method of claim 3, wherein each speech utterance has a duration less than about three seconds.

5. The method of claim 1, wherein the match score comprises a distortion score.

6. The method claim 1, wherein the template comprises sixteen or less codewords.

7. The method of claim 1, wherein the template comprises eight codewords.

8. The method of claim 1, wherein enrollment comprises generating a code book for the subject based on at least the first and second instances of the biometric input.

9. The method of claim 1, further comprising comparing feature vectors extracted from a third instance of the biometric input of the subject to the template to generate a match score based on a degree of similarity between the first and third instances of the biometric inputs.

10. The method of claim 1, wherein the threshold criteria is based on an equal error rate.

11. The method of claim 10, wherein the equal error rate is defined by a point of intersection between a probability density function for valid subjects and a probability density function for imposters.

12. A system for determining whether to accept a subject for enrollment, comprising:
logic for generating a template from feature vectors extracted from a first instance of a biometric input of a subject;
logic for comparing feature vectors extracted from a second instance of the biometric input of the subject to the template to generate a match score based on a degree of similarity between the first and second instances of the biometric inputs; and
logic for accepting the subject for enrollment in a biometric system if the match score meets a threshold criteria.

13. The system of claim 12, wherein the subject is rejected for enrollment in the biometric system if the match score fails to meet the threshold criteria.

14. The system of claim 12, wherein each biometric input comprises a speech utterance.

15. The system of claim 14, wherein each speech utterance has a duration less than about three seconds.

16. The system claim 12, wherein the template comprises sixteen or less codewords.

17. A computer program product for determining whether to accept a subject for enrollment, comprising:
computer code for generating a template from feature vectors extracted from a first instance of a biometric input of a subject;
computer code for comparing feature vectors extracted from a second instance of the biometric input of the subject to the template to generate a match score based on a degree of similarity between the first and second instances of the biometric inputs; and
computer code for accepting the subject for enrollment in a biometric computer program product if the match score meets a threshold criteria.

18. The computer program product of claim 12, wherein the subject is rejected for enrollment in the biometric computer program product if the match score fails to meet the threshold criteria.

19. The computer program product of claim 12, wherein each biometric input comprises a speech utterance.

20. The computer program product of claim 14, wherein each speech utterance has a duration less than about three seconds.
